(19) United States
(12) Patent Application Publication
(10) Pub. No.: US 2025/0170604 A1
(43) Pub. Date: May 29, 2025

(54) CONTINUOUS FEED ACTIVE ROTATIONAL NOZZLE

(71) Applicants: Khalifa University of Science and Technology, Abu Dhabi (AE); Aerospace Holding Company LLC, Abu Dhabi (AE)

(72) Inventors: Laith ABUASSI, Abu Dhabi (AE); Abdulla AYYAD, Abu Dhabi (AE); Ahmad AL-JARAH, Abu Dhabi (AE); Yahya AL-ZWEIRI, Abu Dhabi (AE); Abdelqader ABUSAFIEH, Abu Dhabi (AE)

(21) Appl. No.: 18/523,258

(22) Filed: Nov. 29, 2023

(51) Int. Cl. B05B 13/06; B05B 3/02

(52) U.S. Cl. CPC B05B 13/0636; B05B 3/026

(57) ABSTRACT

Embodiments of the present technology may include a system for coating surfaces. The system can include a rotatable nozzle. The rotatable nozzle can include a plurality of output ports. The plurality of output ports can dispense liquid material on surfaces. The system can also include a housing enclosure. The housing enclosure can include a motor. The motor can rotate the rotatable nozzle. The housing enclosure can also include a solid straight pipe passing through the motor. The solid straight pipe can continuously provide the liquid material to the rotatable nozzle concurrently with rotational action.

### BACKGROUND OF THE INVENTION

Surface operation processes such as coating, cleaning, and polishing can be important in multiple industrial sectors including aerospace, military, and automation. Such operation processes can enhance appearance, protection, and performance of various materials and systems. Application of coating can provide surfaces with resistance to wear, corrosion, and weathering. Cleaning and polishing can prepare surfaces for further treatment or improve a surface finish. Effective surface treatment can ensure long-term functionality and durability of a final product.

A prominent application of surface operations can be coating. A coating process can be important for surface protection and functionality enhancement. Various coating methods can be used in industry including spraying, dipping, brushing, roll coating, etc. These coating methods can aim to precisely apply a coating/painting layer to a surface of a substrate. Before applying a coating material, a cleaning process can be carried out to achieve an optimal surface finish and material adhesion. Surface contamination, such as oil, grease, dirt, or rust, can reduce adhesion of the coating and lead to defects such as blistering or flaking. Effective cleaning methods can be important to ensuring a high-quality coating performance.

Surface cleaning can also be performed using several methods including manual cleaning, solvent cleaning, abrasive cleaning, water cleaning, etc. Manual cleaning can involve use of hand tools (e.g., wire brushes, scrapers, sandpaper, etc.) to remove contaminants from a surface. Solvent cleaning can employ special solvents such as acetone or denatured alcohol to dissolve and remove contaminants. Abrasive cleaning can use abrasive methods such as sandblasting or grinding to physically remove contaminants. Water cleaning can involve water combined with a detergent to remove surface contaminants. Each surface cleaning method can have advantages and disadvantages and can be selected based on a specific situation.

A polishing process can be carried out to smoothen the surface of a material. The polishing process can be performed using abrasives and other polishing compounds to improve appearance, durability, and/or functionality of various materials, including metals, plastics, glass, etc. Polishing can also help remove scratches, stains, and/or other surface imperfections. The polishing process can involve several stages, including rough polishing, fine polishing, buffing, etc. Rough polishing can remove visible scratches or other surface imperfections. Fine polishing can create a smoother finish. Buffing can create a high-gloss finish. A choice of polishing materials and tools can depend on a type of material polished as well as a desired finish.

### BRIEF SUMMARY OF THE INVENTION

A system described herein can coat surfaces. The system can include a rotatable nozzle. The rotatable nozzle can include a plurality of output ports. The plurality of output ports can dispense liquid material on surfaces. The system can also include a housing enclosure. The housing enclosure can include a motor. The motor can rotate the rotatable nozzle. The housing enclosure can also include a solid straight pipe passing through the motor. The solid straight pipe can continuously provide the liquid material to the rotatable nozzle concurrently with rotational action.

In another example, a system described herein can include a robot arm system. The robot arm system can include a manipulator. The manipulator can move a coating end-effector to a predetermined location for performing a coating operation relative to a specified surface. The robot arm system can also include at least one coating end-effector. The at least one coating end-effector can include a rotational nozzle. The rotational nozzle can include a plurality of output ports. The output ports can dispense liquid material on surfaces. The at least one coating end-effector can also include a housing enclosure. The housing enclosure can include a motor. The motor can rotate the rotatable nozzle. The housing enclosure can also include a solid straight pipe passing through the motor. The solid straight pipe can continuously provide the liquid material to the rotatable nozzle concurrently with rotational action.

### BRIEF DESCRIPTION OF THE DRAWINGS

FIG. 1 is a schematic of a cross-section view of a rotational nozzle system according to some aspects of the present disclosure.

FIGS. 2A and 2B are images of cross-section views of exemplary rotational nozzles according to some aspects of the present disclosure.

FIG. 3 is an image of a perspective view of a cleaning end effector for a robotic system that includes a rotational nozzle system according to some aspects of the present disclosure.

FIG. 4 is an additional image of a perspective view of a cleaning end-effector for a robotic system that includes a rotational nozzle system according to some aspects of the present disclosure.

FIG. 5 is an image of a perspective view of a coating end effector for a robotic system that includes a rotational nozzle system according to some aspects of the present disclosure.

FIG. 6 is an image depicting an alignment of a cleaning end effector that includes a rotational nozzle system with a target hole by a manipulator of a robotic system according to some aspects of the present disclosure.

FIG. 7 is an image of a rotational nozzle system including a robotic arm according to some aspects of the present disclosure.

FIG. 8 is a schematic showing multiple views for various different use cases of a rotational nozzle system according to some aspects of the present disclosure.

FIG. 9 is a schematic of a cross-section view of an endoscope guided rotational nozzle system according to some aspects of the present disclosure.

FIG. 10 is a schematic of a cross-section view of a robot guided rotational nozzle system according to some aspects of the present disclosure.

FIG. 11 is a schematic of a rotational nozzle in various stages of a cleaning process according to some aspects of the present disclosure.

FIG. 12 is a schematic of a cross-section view of a rotational nozzle system for polishing a surface of a workpiece according to some aspects of the present disclosure.

FIG. 13 is a schematic of a cross-section view of an automatic self-feeding machining bit system according to some aspects of the present disclosure.

FIG. 14 is a flow chart of an example of a process for coating surfaces of a workpiece using a robotic system according to some aspects of the present disclosure.

FIG. 15 is a block diagram of an example robotic system computing controller for controlling a robotic system as the robotic system completes manufacturing tasks such as coating tasks according to some aspects of the present disclosure.

### DETAILED DESCRIPTION OF THE INVENTION

Certain aspects and examples of the present disclosure relate to a continuous feed active (CFA) rotational nozzle. The CFA rotational nozzle can address problems that may appear with applying coating or solvent-cleaning materials to an internal surface of narrow spaces. A size and shape of the CFA rotational nozzle can be customized so that a coating/cleaning process can be applied with enhanced coating accessibility to an internal surface with small holes with a diameter less than three millimeters, for example. The CFA rotational nozzle can be driven by a hollow shaft motor that can provide continuous rotation of the CFA rotational nozzle while material is injected. The continuous rotation can allow coating to be evenly distributed on the internal surface area while avoiding uneven coating thickness, inadequate coverage, or defect formations. The CFA rotational nozzle can also be employed for surface polishing applications.

A coating or solvent-cleaning process can be performed by applying liquid material on normal surfaces using methods such as direct spraying, dipping, brushing, or roll-coating either manually or automated. But when a target surface is an inner surface of deep or narrow spaces, a use of conventional tools for coating, cleaning, and polishing may not be possible due to limited accessibility. The limited accessibility can be particularly an issue when working inside long and narrow industrial pipes such as pipes found in oil and gas fields. Similar issues can arise when working with pre-coated large workpieces, such as the workpieces found in the aerospace industry. Post-machining processes like drilling, deburring, and riveting may be performed on the pre-coated large workpieces. Recoating such workpieces after the post-machining processes can be challenging and include extensive labor when executed manually.

Accessing internal surfaces of deep and narrow spaces can be challenging in terms of accessibility and nozzle direction. A limited space available can make positioning or moving a spray nozzle or coating mechanism difficult, leading to uneven thickness and inadequate coverage. Additionally, an orientation of the surface can affect a direction of spray, causing a coating or cleaning material to pool in certain areas or run off from other areas. Such pooling or run-off can result in inconsistent coverage, reduced adhesion, and/or potential defects such as drips or sags.

In addition to challenges related to accessibility and nozzle direction, other difficulties can arise when coating an inner surface of a narrow space or workpiece. For example, a presence of obstructions such as corners, edges, or other geometrical features can create shadow areas where coating may not be applied evenly. The creation of shadow areas can lead to areas of incomplete coverage or lower adhesion and increase a risk of corrosion, erosion, and/or wear. The CFA rotational nozzle can be designed to overcome the aforementioned challenges and difficulties.

A system that includes the CFA rotational nozzle can include two main portions: a housing enclosure for the CFA rotational nozzle and the CFA rotational nozzle. For certain applications, the CFA rotational nozzle can detach from the housing enclosure. The housing enclosure can include several components. Examples of the components can include a liquid material input port, a hollow shaft motor, and a straight solid pipe for delivering liquid material to the CFA rotational nozzle. The CFA rotational nozzle can include a rotational sealed bearing, rotary shaft seal, and O-Rings for rotating around the straight solid pipe. The rotational sealed bearing, rotary shaft seal, and the O-Rings can prevent leakage outside of nozzle components. The O-Rings can facilitate an insertion of the straight solid pipe into an internal section of the rotational sealed bearing, for example, during applications when the CFA rotational nozzle is detachable. Material can be distributed outside the CFA rotational nozzle through an arrangement of output ports. A design arrangement of the output ports of the CFA rotational nozzle can depend on an application of the system. Sizes of the output ports can depend on rotational speed of the CFA rotational nozzle, related material properties of the liquid, or both. The related material properties of the liquid can include viscosity, adhesion, and/or cohesion.

The system can operate so that a rotational nozzle mechanism and a material injection is synchronized. Features of the CFA rotational nozzle can be adapted based on an application. The system can be a part of a hand-held device, part of a machine (e.g., a computerized numerical control (CNC) machine, a Lathe machine, a drilling machine, etc.), or attached to a robotic arm. The system can continuously feed the liquid material inside the rotational nozzle. Different nozzle head shapes and sizes can be designed based on the application. An inner/outer structure design of the rotational nozzle head, a rotational speed, liquid material viscosity, and/or injection pressure of the liquid material can be combined to generate many different operational scenarios to handle different applications.

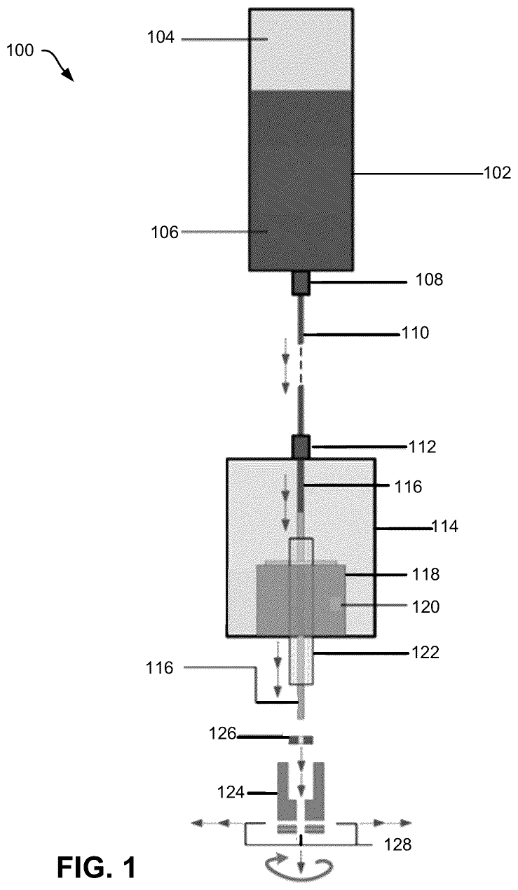

FIG. 1 is a schematic of a cross-section view of a rotational nozzle system 100 according to some aspects of the present disclosure. The rotational nozzle system 100 can include three sections including a liquid material container 102, a housing enclosure 114, and a rotational nozzle 124. The rotational nozzle 124 is a CFA rotational nozzle. The liquid material container 102 can include an injection mechanism 104, a liquid material reservoir 106, and a liquid material output port 108. A type of liquid within the liquid material container 102 can be based on an application for the rotational nozzle system 100. Types of liquid can include cleaning liquids, water or water-based liquids, grease, paint, coating liquids, thread locking liquids, oils, polishing liquids, etc.

The housing enclosure 114 can include a liquid material input port 112, a solid straight pipe 116, and a hollow shaft motor 118. The hollow shaft motor 118 can include a stator 120 and a rotor 122. The housing enclosure 114 can fix the stator 120 of the hollow shaft motor 118 and the liquid material input port 112 together as a single unit. The solid straight pipe 116 can be fixed to the liquid material input port 112 of the housing enclosure 114. The liquid material output port 108 of the liquid material container 102 can be linked to the liquid material input port 112 of the housing enclosure 114 by an extension pipe 110. In some examples, the extension pipe 110 can include a solid straight pipe or include at least a portion that is a flexible pipe.

The rotational nozzle 124 can include one or more output ports 128 and a rotational sealant mechanism 126. Parameters of the rotational nozzle system 100 can be based on an application for the rotational nozzle system 100. For example, a size, number, distribution, or location of the one or more output ports 128 can depend on the application for the rotational nozzle system 100. Other parameters of the rotational nozzle system 100 can include an inner and/or outer structure design of the rotational nozzle 124, a rotational speed of the rotational nozzle, a coating material viscosity, an injection pressure of the coating material, an inclination angle associated with each output port, etc. The number of multiple output ports 128 can be any value including one single output port or multiple output ports. The rotor 122 of the hollow shaft motor 118 and the rotational nozzle 124 can be fixed together so that the hollow shaft motor 118 can continuously rotate the rotational nozzle 124. The solid straight pipe 116 can pass through the hollow shaft motor 118 without making contact with the rotor 122. The solid straight pipe 116 can be inserted into an internal section of the rotational sealant mechanism 126 with a presence of an O-ring. The solid straight pipe 116 may function to inject liquid material inside the rotational nozzle 124.

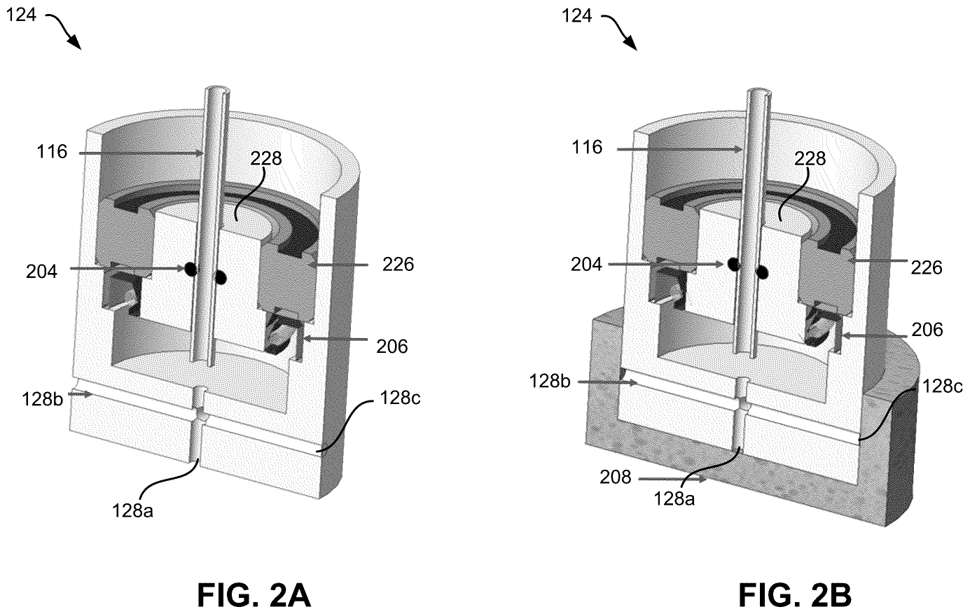

FIGS. 2A and 2B are images of cross-section views of exemplary rotational nozzles 124 according to some aspects of the present disclosure. The rotational nozzle 124 can be referred to as a CFA rotational nozzle. The rotational nozzle 124 can include output ports 128 (e.g., individually labeled 128a, 128b, and 128c in FIGS. 2A and 2B, although any suitable number including a single output port may be utilized), a solid straight pipe 116, O-ring 204, and components of a rotational sealant mechanism 126. Components of the rotational sealant mechanism can include a rotary bearing 226 and a rotary shaft seal 206. The output ports 128 can include a vertical output port 128a and/or radial output ports 128b-c. The vertical output port 128a can be parallel to or aligned with the solid straight pipe 116. Thus, an alignment angle between the vertical output port 128a and the solid straight pipe 116 can be 0°. In other examples, the alignment angle (or inclination angle) between the vertical output port 128a and the solid straight pipe 116 can take on any value between 90° and −90°. A diameter of the vertical output port 128a can have a similar or different size as diameters of the radial output ports 128b. The diameter of the vertical output port 128a and the diameters of the radial output ports 128b can be modified based on an application of the rotational nozzle 124. The O-ring 204 can be an internal O-ring between the solid straight pipe 116 and either an internal part of the rotary bearing 226, or an internal part of the rotary shaft seal 206. A mechanical design flexibility of the rotational nozzle 124 can be enhanced by installing a customized impermeable coupling 228 that connects the solid straight pipe 116 to an internal part of the rotary bearing 226 and the rotary shaft seal 206. The customized impermeable coupling 228 can allow for a wide range of size options for the solid straight pipe 116, the rotary bearing 226, and the rotary shaft seal 206. The sealed bearing 226, rotary shaft seal 206, and the O-ring 204 can prevent leakage outside of nozzle components. The O-ring 204 can facilitate an insertion of the solid straight pipe 116 into an internal section of the sealed bearing 226, for example, during applications when the rotational nozzle 124 is detachable.

Although a single vertical output port 128a is shown in FIG. 2A and FIG. 2B, any number of vertical output ports can be included in the rotational nozzle 124, including zero vertical output ports. Similarly, although two radial output ports 128b-c are shown in FIG. 2, any number of radial output ports can be included in the rotational nozzle 124, including zero radial output ports 128b-c. A number and arrangement of vertical output ports 128a and a number and arrangement of radial output ports 128b-c can be determined based on the application for the rotational nozzle 124. Although FIGS. 2A and 2B includes a combination of vertical output ports 128a and radial output ports 128b-c, in some examples, the rotational nozzle 124 includes only vertical output ports 128a or only radial output ports 128b-c. In some examples, as shown in FIG. 2B, the rotational nozzle 124 can include a sponge head 208. The sponge head 208 can clean or polish surfaces.

### Design of an Intelligent Coating End-Effector

An automation of coating processes in manufacturing such as aerospace manufacturing can present numerous challenges to ensure uniform coating and precise layer thickness. Coating and cleaning of inner walls of machined holes can be important for coating and insulation purposes in the aerospace industry. A Cobot, short for Collaborative Robot, can be a type of robot that works alongside humans to perform tasks in a collaborative manner within a shared workspace. Cobots can be designed to be more flexible, more intelligent, and/or safer than other types of industrial robots. Benefits of using Cobots can include improved quality and productivity. Cobots can remain efficient regardless of hours worked while providing production stability in terms of precision and consistency.

A coating end-effector and/or a cleaning end-effector for Cobot or other robotic systems can assist in automating coating processes of inner surfaces of holes in airplane components. A periodic arrangement of holes can occupy a space of up to tens of meters on a standard large airplane component. Airplane components can be pre-coated by an original manufacturer. But pre-coating layers can be removed leaving holes exposed to erosion when the airplane component undergoes various machining processes such as drilling and deburring. Exposed internal surfaces of the uncoated holes can be re-coated manually, but manual re-coating can involve extensive labor and working hours and can be imprecise. The coating end-effector for Cobot systems can automate a re-coating process and provide precise coating results.

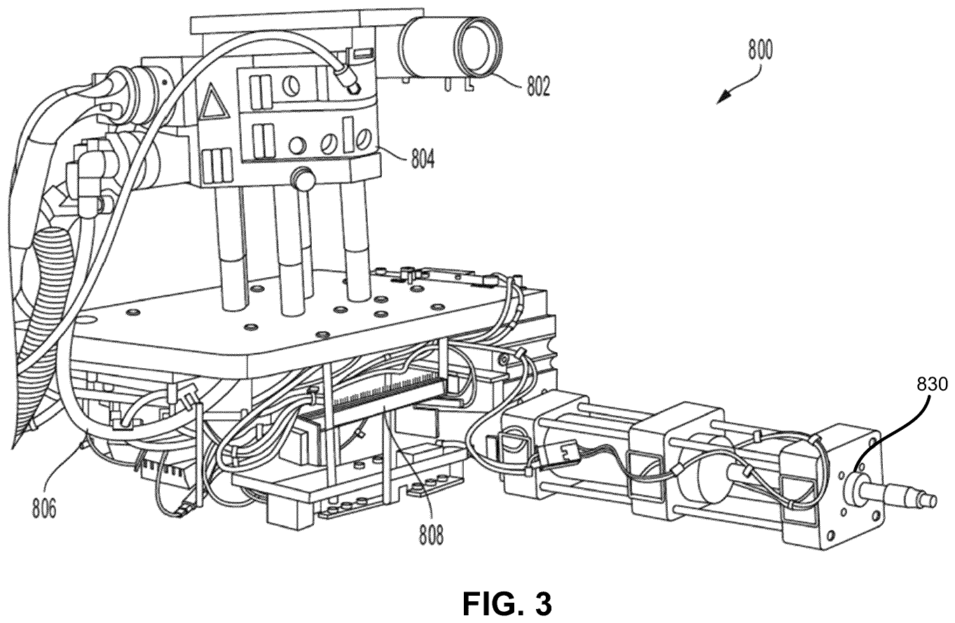

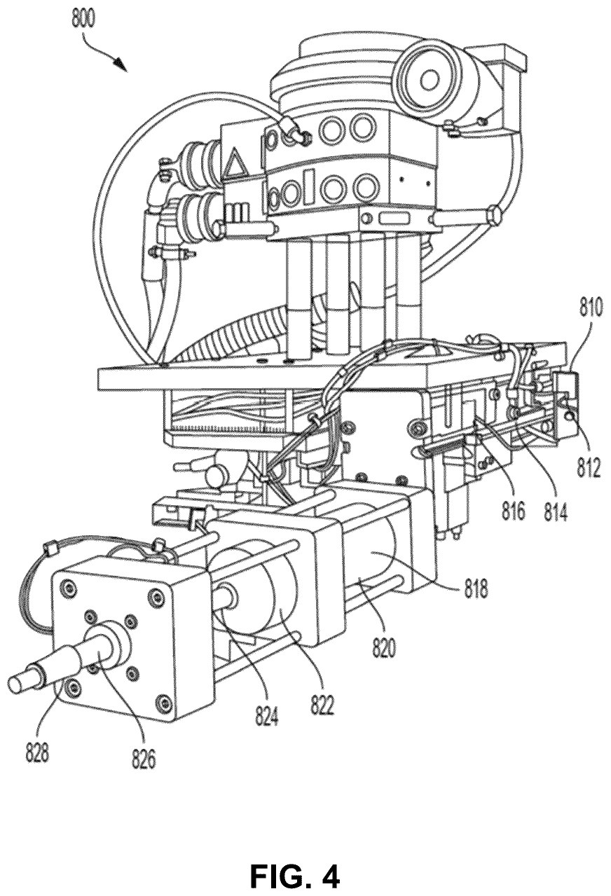

FIG. 3 is an image of a perspective view of a cleaning end-effector 800 for a Cobot that includes a rotational nozzle system according to some aspects of the present disclosure. FIG. 4 is an additional image of a perspective view of the cleaning end-effector 800 for a Cobot that includes a rotational nozzle system according to some aspects of the present disclosure. The rotational nozzle system can be rotational nozzle system 100 described in FIG. 1. The cleaning end-effector 800 can be used for multiple applications including cleaning and/or coating inner surfaces of drilled holes located on pre-coated airplane parts. In some examples, the inner surfaces can be internal surfaces of hollow cylindrical shape parts. The internal surfaces can be regular or irregular surfaces. The intelligent end-effector 800 can include a lead screw mechanism 814, a stepper motor 810, a hollow shaft stepper motor 830, a syringe reservoir/barrel 820, a syringe plunger 818, a long syringe needle 824, stepper motors' controllers 806, an microcontroller 808, a camera 802, a tool changer 804, an upper level limit switch 812, a lower level limit switch 816, cleaning solution 822, and a rotational nozzle that can include a disposable sponge head 828 (or may be utilized with a disposable sponge head 828 omitted) and a hollow shaft 826. The rotational nozzle can be rotational nozzle 124 described in FIG. 1 and the hollow shaft stepper motor 830 can be hollow shaft motor 118 from FIG. 1. The disposable sponge head 828 can be used to clean surfaces.

The syringe reservoir/barrel 820 can store the cleaning solution 822. A type of cleaning solution 822 can be based on an application for the coating end-effector 800. The syringe plunger 818 can expel/dispense the cleaning solution 822. The long syringe needle 824 can deliver the cleaning solution 822 to a head of the nozzle and/or disposable cylindrical sponge 828 through the hollow shaft stepper motor 830. The long syringe needle 824 can include dimensions such as a length of 80 mm and a diameter of 1 mm. Limit switches 812, 816 can be mounted to monitor upper and lower levels of the syringe reservoir/barrel 820 during operation. The stepper motor 810 can be attached to and used to drive the lead screw mechanism 814. A model 17HDC4069Z-352N15 is one example of the stepper motor 810. The lead screw mechanism 814 can convert rotational motion into linear motion with a very high resolution of 0.05 mm and can drive the syringe plunger 818 to control dispensing action. A high-resolution motion of the stepper motor 810 can be achieved through micro-stepping control implemented using a DM320T stepper motor driver. A model 8HY0001-7SK can be used as the hollow shaft stepper motor 830. A stationary part of the hollow shaft stepper motor 830 can be connected to the end-effector's housing while a dynamic part can be connected with the nozzle and/or disposable sponge head 828. The disposable sponge head 828 can rotate at a same speed as the rotational nozzle 124. The hollow shaft 826 can allow the long syringe needle 824 to reach and carry the cleaning solution 822 to the nozzle and/or disposable sponge head 828. The hollow shaft stepper motor 830 can ensure uniform/homogeneous coating of inner surfaces of primary holes by continuously rotating the nozzle and/or disposable sponge head 828 of the rotational nozzle during dispensing action. The microcontroller 808 can serve as an independent controller and can communicate with a main controller of the Cobot to trigger both stepper motors simultaneously and monitor coating solution level and a location of the syringe plunger's end via the upper-level limit switch 812 and the lower-level limit switch 816. An Arduino controller is one example of the microcontroller 808. A first mechanical coupling can be established between a dispensing mechanism and a stationary side of the hollow shaft stepper motor 830. A second mechanical coupling can be established between the rotational sponge head 828 and a rotating part of the hollow shaft stepper motor 830.

In some examples, the cleaning end effector 800 can include a precise injection mechanism. The injection mechanism can be based on a stepper motor linear actuator (e.g., NEMA17) that drives a syringe plunger with a high-precision movement using micro-stepping control. The syringe reservoir can include a 60 ml syringe with a long needle (80 mm long and a diameter of 1 mm), where coating material can get injected. When reaching the rotatable nozzle, the coating material can get evenly distributed on an internal surface, such as of a ( 3/16″) diameter and (⅛″) thickness hole. The rotating nozzle can run at a high speed while the injection mechanism pushes the coating material inside. The cobot (or robotic arm, mobile robot, or handheld device) can be programmed to automatically raise or lower the rotational nozzle 124 according to a motion profile such as a linear motion profile. In some examples, the cleaning process can be achieved by simultaneously activating rotational motion of the rotational nozzle 124, injection of cleaning material, and automatic linear motion (raising or lowering) of the rotational nozzle 124. The microcontroller 808 can synchronize all operations together to perform proper coating results.

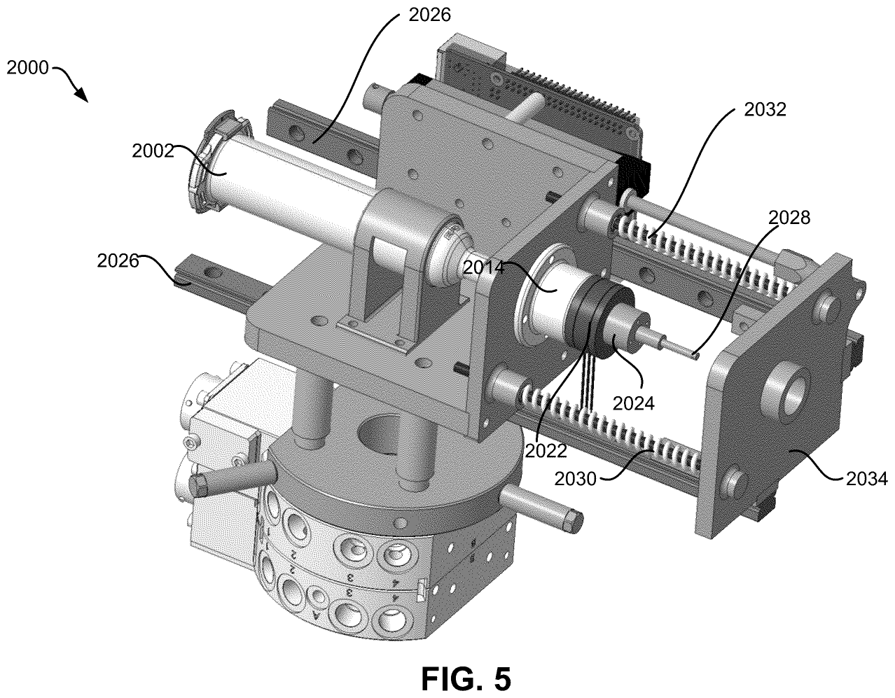

FIG. 5 is an image of a perspective view of a coating end effector 2000 for a Cobot or other robotic arm or system that includes a rotational nozzle system according to some aspects of the present disclosure. The rotational nozzle system is a CFA rotational nozzle system and can be rotational nozzle system 100 described in FIG. 1. The coating end-effector 2000 can be used for multiple applications including cleaning inner surfaces of drilled holes located on pre-coated airplane parts. The rotational nozzle system of the coating end effector 2000 can include three sections including a liquid material container 2002, a housing enclosure 2014, and a rotational nozzle 2024. The rotational nozzle 2024 can be a CFA rotational nozzle. The liquid material container 2002 can include an injection mechanism, a liquid material reservoir, and a liquid material output port. A type of liquid within the liquid material container 2002 can be based on an application for the rotational nozzle system.

The housing enclosure 2014 can include a liquid material input port, a solid straight pipe, and a hollow shaft motor 2022. The hollow shaft motor 2022 can include a stator and a rotor. A solid straight pipe can be fixed to the liquid material input port of the housing enclosure 2014. The rotational nozzle 2024 can include multiple output ports 2028 and a sealed bearing. A size, number, or location of the multiple output ports 2028 can depend on the application for the rotational nozzle system. The number of multiple output ports 2028 can be any value including one single output port. The rotor of the hollow shaft motor 2022 and the rotational nozzle 2024 can be fixed together so that the hollow shaft motor 2022 can continuously rotate the rotational nozzle 2024. The solid straight pipe can pass through the hollow shaft motor 2022 without making contact with the rotor.

The coating end-effector 2000 can also include components for passive self-alignment of the coating end-effector 2000. The components can include linear sliders 2026, compression springs (e.g., compression spring 2030 or compression spring 2032), and a contact pad 2034. Details for self-aligning of the coating end-effector using the components for passive self-alignment can be found in U.S. application Ser. No. 18/460,533, filed Sep. 2, 2023, the entire contents of which are hereby incorporated by reference herein.

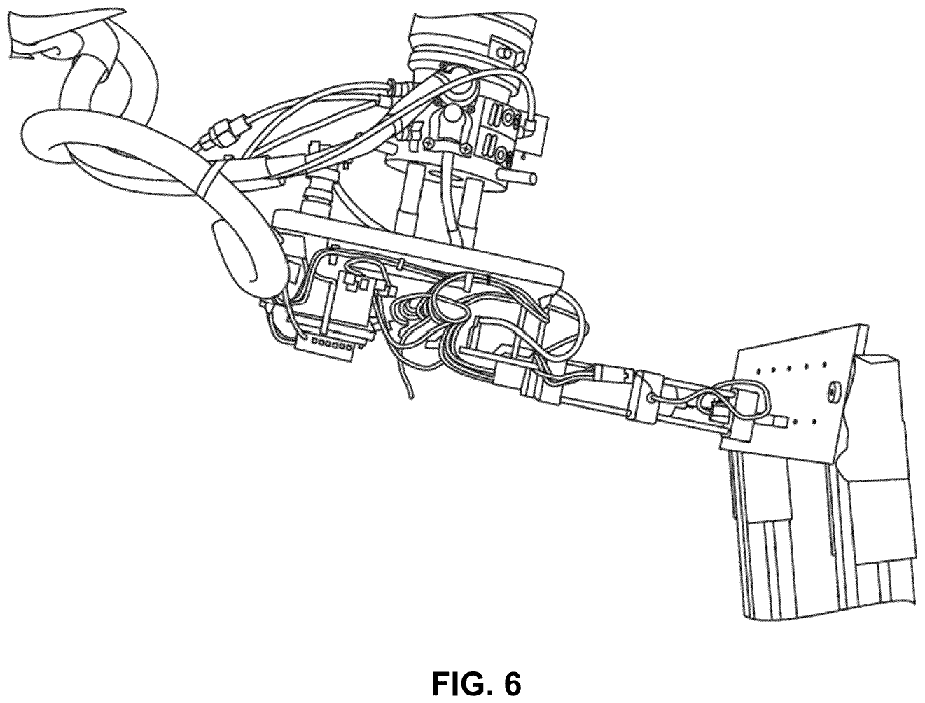

FIG. 6 is an image depicting an alignment of a cleaning end-effector that includes a rotational nozzle system with a target hole by a manipulator of a Cobot or other robotic system according to some aspects of the present disclosure. The cleaning end-effector can be cleaning end-effector 800 described in FIGS. 3 and 4 or coating end-effector 2000 described in FIG. 5. The rotational nozzle system can be the rotational nozzle system 100 described in FIG. 1. An automation flow for coating a target hole using the coating end-effector can proceed as follows. After locating a workpiece (such as by using fiducial markers or other suitable techniques) and detecting target holes in the workpiece, the Cobot can engage the coating end-effector through programmed motion planning.

The Cobot can align the cleaning end-effector with a target target hole for cleaning. The Cobot system can perform vision-based control to align the cleaning end-effector with a target target hole. The Cobot system can monitor a force feedback signal from Cobot joints to ensure that a sponge head or a rotational nozzle system of the end-effector is inside the target hole. When a rigid end of the end-effector touches the workpiece, force readings can increase to indicate that the sponge head rotational nozzle system has reached the target hole. The Cobot system can retract the end-effector to avoid direct contact with the workpiece except for the sponge head or rotational nozzle system. In some examples, the Cobot system can retract two millimeters to avoid the direct contact.

The Cobot can send a trigger signal to a microcontroller to start a cleaning process. After receiving the trigger signal, the microcontroller can send a signal to stepper motors controllers to rotate and start a dispensing action. A programmable precise amount of cleaning solution can be injected inside the disposable sponge head. The precise amount of cleaning solution can be calculated based on measurements of the target hole and a desired layer thickness of the cleaning solution. After a first hole is cleaned, the microcontroller can send an acknowledgement signal to the controller of the Cobot to proceed to another target hole and perform the cleaning process relative to another target hole.

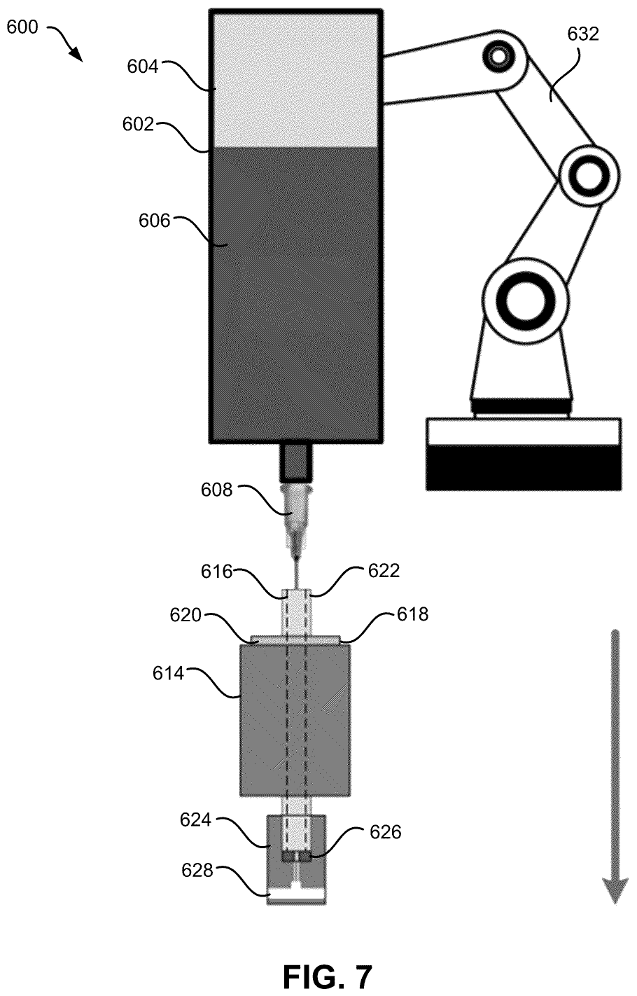

FIG. 7 is an image of a rotational nozzle system 600 including a robotic arm 632 according to some aspects of the present disclosure. The rotational nozzle system 100 can include several sections including a liquid material container 602, a housing enclosure 614, a rotational nozzle 624, and the robotic arm 632. The liquid material container 602 can include an injection mechanism 604, a liquid material reservoir 606, and a liquid material output port 608. A type of liquid within the liquid material container 602 can be based on an application for the rotational nozzle system 600.

The housing enclosure 614 can include a solid straight pipe 616 (represented by dashed lines in FIG. 7), a stator 620 of a hollow shaft motor 618, and a rotor 622 of the hollow shaft motor 618. The liquid material output port 608 of the liquid material container 602 can be linked to the housing enclosure 614 by a flexible extension pipe.

The rotational nozzle 624 can include multiple output ports 628 and a sealed bearing 626. A size, number, or location of the multiple output ports 628 can depend on the application for the rotational nozzle system 600. Although two radial output ports are shown in FIG. 7, the multiple output ports 628 can include any number of vertical output ports or any number of radial output ports including zero radial output ports. The rotor 622 of the hollow shaft motor 618 and the rotational nozzle 624 can be fixed together so that the hollow shaft motor 618 can continuously rotate the rotational nozzle 624. The solid straight pipe 616 can pass through the hollow shaft motor 618 and can be inserted into the sealed bearing 626 to inject liquid material inside the rotational nozzle 624.

The robotic arm 632 can be attached to the liquid material container 602 and/or the housing enclosure 614 and can automatically position the rotational nozzle 624 near or within a target component of a workpiece. The rotational nozzle system 600 can continuously feed liquid material inside the rotational nozzle 624 until a target thickness of coating has been deposited onto the target component. The robotic arm 632 can move the rotational nozzle 624 to a new target component after a coating deposition is completed.

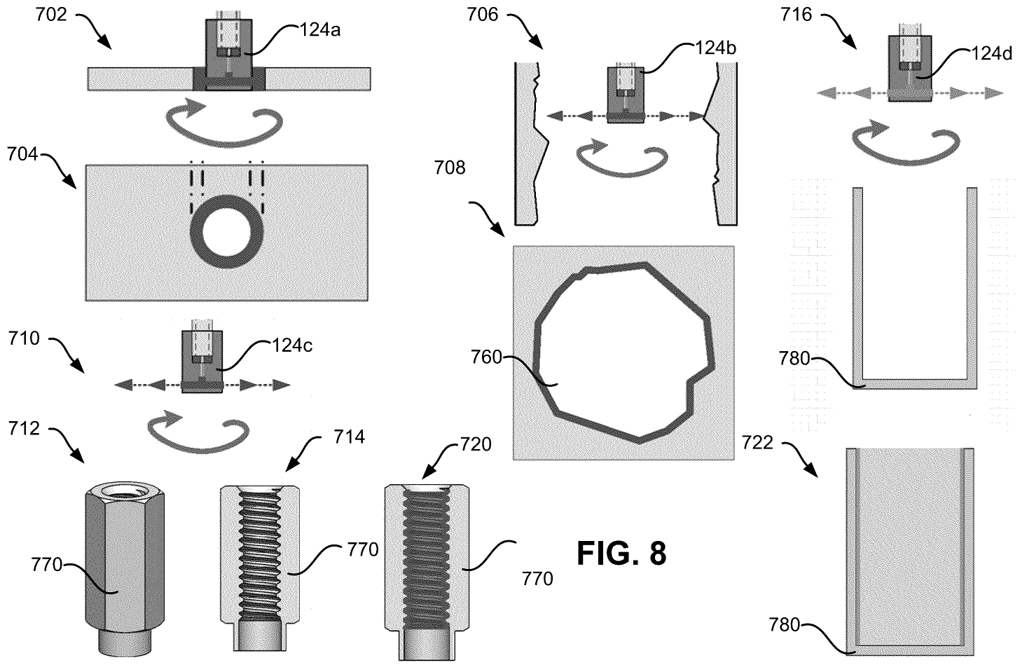

FIG. 8 is a schematic showing multiple views for various different example use cases of a rotational nozzle system according to some aspects of the present disclosure. A first use case (case 1) of the rotational nozzle system can involve coating a hole that lost a coating during drilling. FIG. 8 shows a cross sectional view 702 of a rotational nozzle 124a adapted to coat the hole 750 and a top view 704 of the hole 750 after coating. For simplicity, only the rotational nozzle 124a of the rotational nozzle system is shown in all views in FIG. 8. An outer surface of the rotational nozzle 124a can be treated with a nano-ceramic material. Treatment with the nano-ceramic material can enable an accurate injection of coating material into the hole. The nano-ceramic material can prevent adhesion between the coating material and an outer surface of the rotational nozzle 124a and ensure that the rotational nozzle 124a does not remove coating material when the rotational nozzle is extracted from the hole. Example of nanoceramic materials can include simple metal oxides, such as silica, titania, alumina, iron oxide, zinc oxide, ceria, zirconia, and etc. To coat the hole 750, the rotational nozzle 124a can be inserted and positioned within the hole 750 along a bottom depth of the hole 750 or along any depth position of the hole 750. A hollow shaft motor can begin rotating the rotational nozzle 124a at a relatively low angular speed and coating material can be continuously injected into the rotational nozzle 124a. The position of the rotational nozzle 124a can be raised or lowered to coat the hole 750 at all depths. After the entire internal surface of the hole 750 is coated with a predetermined coating thickness, the rotational nozzle system can stop injecting coating material into the rotational nozzle 124a, the hollow shaft motor can stop rotating the rotational nozzle 124a, and the rotational nozzle 124a can be extracted from the hole 750.

A second use case (case 2) of the rotational nozzle system can involve coating an internal surface of a narrow space or hole 760 with an irregular internal surface. FIG. 8 shows a prior to coating cross sectional view 706 of a rotational nozzle 124b adapted to coat the narrow space or hole 760 and a top view 708 of the narrow space or hole 760 after coating. For simplicity, only the rotational nozzle 124b of the rotational nozzle system is shown in all views in FIG. 8. To coat the narrow space or hole 760, the rotational nozzle 124b can be inserted and positioned within the narrow space or hole 760 along any depth position of the narrow space or hole 760. The hollow shaft motor can begin rotating the rotational nozzle 124b at a high angular speed to allow injected material to be expelled by a centrifugal force and the coating material can be continuously injected into the rotational nozzle 124b. The position of the rotational nozzle 124b can be raised or lowered to coat the hole 760 at all depths or any combination of depths. For example, a robotic arm or handheld tool can be programmed to automatically raise or lower the rotational nozzle 124b according to a motion profile such as a linear motion profile. After the entire internal surface of the narrow space or hole 760 is coated with a predetermined coating thickness, the rotational nozzle system can stop injecting coating material into the rotational nozzle 124b, the hollow shaft motor can stop rotating the rotational nozzle 124b, and the rotational nozzle 124b can be extracted from the narrow space or hole 760.

A third use case (case 3) of the rotational nozzle system can involve applying thread-locking material or other coating on an internal surface of a nut 770 (such as a hex nut or other form of nut). The nut 770 can be normal sized, unusually long and/or narrow, small, or large. FIG. 8 shows a cross-sectional view 710 of a rotational nozzle 124c adapted to apply the thread-locking material to the nut 770 and a perspective view 712 and cross-sectional view 714 of the nut 770 prior to application of the thread-locking material. FIG. 8 also shows a cross-sectional view 720 of the nut 770 after application of the thread-locking material. For simplicity, only the rotational nozzle 124c of the rotational nozzle system is shown in all views in FIG. 8. To apply thread-locking material to the nut 770, the rotational nozzle 124c can be inserted and positioned within the nut 770, such as at a center of the nut 770 and along any depth position or combination of depths of the nut 770. The hollow shaft motor can begin rotating the rotational nozzle 124c at a high angular speed to allow injected material to be expelled by a centrifugal force and the coating material can be continuously injected into the rotational nozzle 124c. The angular speed can be based on characteristics of the coating material (e.g., viscosity, adhesion, etc.), injection pressure, a distance between the rotational nozzle 124c and a coating surface, dimensions of the nut 770, or on a pre-determined target coating thickness of the coating material. A coating thickness can be either the pre-determined target coating thickness or a random coating thickness. For example, random coating thickness can occur due to a large distance between an internal surface of a hollow cylindrical shape part of the nut 770 and a center of the rotational nozzle 124c. The predetermined coating thickness can be achieved due to a small clearance between internal surfaces of the hollow cylindrical shape part and an outside surface of the rotational nozzle 124c. Both the hollow cylindrical shape and the rotational nozzle 124c can have a regular cylindrical shape. At low angular speeds for the rotational nozzle 124c, the coating material can be distributed on the internal surface of a regular hollow cylindrical shape of the nut 770 by a rubbing effect generated by the low-speed rotation of the rotational nozzle 124c. The position of the rotational nozzle 124c can be raised or lowered to coat the nut 770 at all depths. For example, a robotic arm, mobile robot, or handheld tool can be programmed to automatically raise or lower the rotational nozzle 124c according to a motion profile such as a linear motion profile. In some examples, the coating process can be achieved by simultaneously activating rotational motion of the rotational nozzle 124c, injection of coating material, and automatic linear motion (raising or lowering) of the rotational nozzle 124c. After an entire internal surface of the hex nut 770 is coated with a predetermined applied thickness of the thread-locking material, the rotational nozzle system can stop injecting thread-locking material into the rotational nozzle 124c, the hollow shaft motor can stop rotating the rotational nozzle 124c, and the rotational nozzle 124c can be extracted from the hex nut 770.

A fourth use case (case 4) of the rotational nozzle system can involve applying oil or grease material on an internal surface of a piston 780. The piston 780 can be normal sized, unusually long and/or narrow, small, or large. FIG. 8 shows a cross-sectional view 716 of a rotational nozzle 124d adapted to apply the oil or grease material to the piston 780. FIG. 8 also shows a cross-sectional view 722 of the piston 780 after application of the oil or grease material. For simplicity, only the rotational nozzle 124d of the rotational nozzle system is shown in all views in FIG. 8. To apply oil or grease material to the piston 780, the rotational nozzle 124d can be inserted and positioned within the piston 780 along any depth position or combination of depths of the piston 780. The hollow shaft motor can begin rotating the rotational nozzle 124d at a high angular speed to allow injected material to be expelled by a centrifugal force and the oil or grease material can be continuously injected into the rotational nozzle 124d. The angular speed can be based on characteristics of the coating material (e.g., viscosity, adhesion, etc.), injection pressure, a distance between the rotational nozzle 124c and a coating surface, dimensions of the piston 780, or on a pre-determined target coating thickness of the coating material. The position of the rotational nozzle 124d can be raised or lowered to coat the piston 780 at all depths or any combination of depths. For example, a robotic arm can be programmed to automatically raise or lower the rotational nozzle 124d according to a motion profile such as a linear motion profile. Alternatively, handheld tool can be used to raise or lower the rotational nozzle 124d. After an entire internal surface of the piston 780 is coated with a predetermined applied thickness of the oil or grease material, the rotational nozzle system can stop injecting oil or grease material into the rotational nozzle 124d, the hollow shaft motor can stop rotating the rotational nozzle 124d, and the rotational nozzle 124d can be extracted from the piston 780.

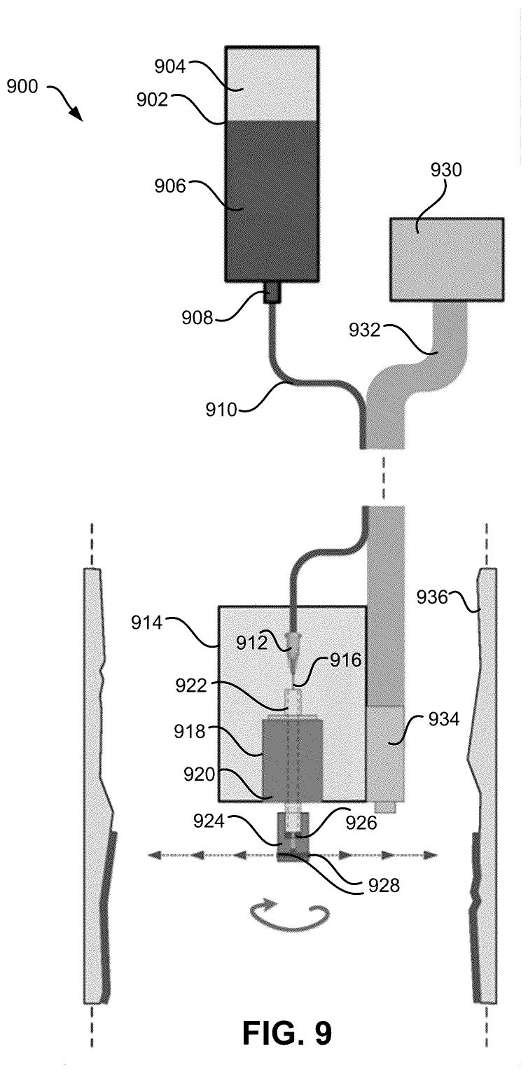

FIG. 9 is a schematic of a cross-section view of an endoscope guided rotational nozzle system 900 according to some aspects of the present disclosure. The endoscope guided rotational nozzle system 900 can include multiple sections including a liquid material container 902, a housing enclosure 914, a rotational nozzle 924, and an endoscope system. The liquid material container 902 can include an injection mechanism 904, a liquid material reservoir 906, and a liquid material output port 908. A type of liquid within the liquid material container 902 can be based on an application for the endoscope guided rotational nozzle system 900.

The housing enclosure 914 can include a liquid material input port 912, an injection needle 916, and a hollow shaft motor 918. The hollow shaft motor 918 can include a stator 920 and a rotor 922. The injection needle 916 can be fixed to the liquid material input port 912 of the housing enclosure 914. The liquid material output port 908 of the liquid material container 902 can be linked to the liquid material input port 912 of the housing enclosure 914 by a flexible extension pipe 910.

The rotational nozzle 924 can include multiple output ports 928 and a sealed bearing 926. A size, number, or location of the multiple output ports 928 can depend on the application for the endoscope guided rotational nozzle system 900. The rotor 922 of the hollow shaft motor 918 and the rotational nozzle 924 can be fixed together so that the hollow shaft motor 918 can continuously rotate the rotational nozzle 924. The injection needle 916 can pass through the hollow shaft motor 918 and be inserted into the sealed bearing 926 to inject liquid material inside the rotational nozzle 924.

The endoscope system can include an endoscope head guided motion controller 930, an endoscope probe 932 connected at a first end to the endoscope head guided motion controller 930, and an endoscope camera 934 connected to a second end of the endoscope probe 932. The endoscope camera 934 and the endoscope probe 932 can be fixed to the housing enclosure 914 and most of a length of the endoscope probe 932 can be attached to the flexible extension pipe 910. The housing enclosure 914 can be a mini low weight housing enclosure that is compatible with endoscope applications.

The endoscope guided rotational nozzle system 900 can coat surfaces of objects including internal surfaces of irregular objects such as irregular object 936. An irregular object 936 can have a cross-section that is irregularly shaped with jagged edges or a cross-section shape that varies with depth. The endoscope camera 934 can inspect a coating process and the endoscope head guided motion controller 930 can monitor images from the endoscope camera 934 and help guide the rotational nozzle 924 during the coating process. A rotational nozzle controller can adjust parameters of the coating process based on the monitored images. For example, the rotational nozzle system controller can cause the rotational nozzle 924 to tilt to ensure uniform coating of the internal surface of the irregular object 936. In another example, the monitored images can detect poor coating coverage along surfaces that are remote from the rotational nozzle 924 and the rotational nozzle controller can adjust nozzle angular speed to improve coating coverage along those surfaces.

The coating process can involve positioning the rotational nozzle 924 at a depth (e.g., a bottom depth) associated with the irregular object 936. The rotational nozzle 924 can be rotated by the hollow shaft motor 918 and coating material can be continuously injected into the rotational nozzle 924 by the injection needle 916 during the coating process. The rotational nozzle 924 can be lifted (or lowered) in order to coat all depths of the irregular object 936 or any combination of depths. Motion of the rotational nozzle 924 can be adjusted by the endoscope head guided motion controller 930 based on inspection of the coating process via the endoscope camera 934. The endoscope head guided motion controlled 930 can control motion of the rotational nozzle 924 by adjusting either a linear vertical motion or a tilt motion of the rotational nozzle 924. Once the entire internal surface is coated, injection of the coating material can cease and the hollow shaft motor 918 can stop rotating the rotational nozzle 924.

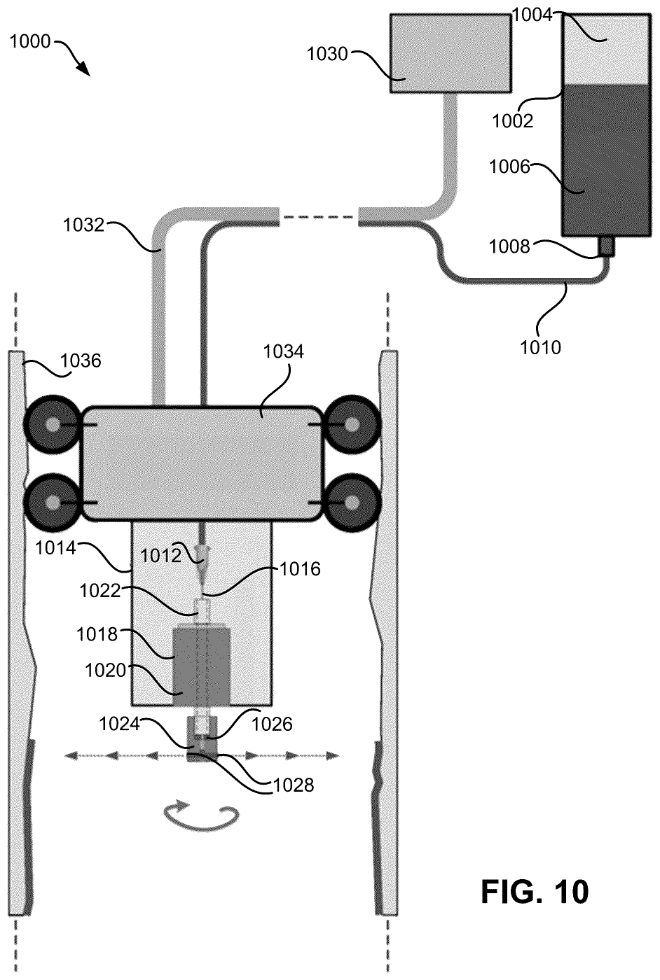

FIG. 10 is a schematic of a cross-section view of a robot guided rotational nozzle system 1000 with robot components according to some aspects of the present disclosure. The guided rotational nozzle system 1000 can include multiple sections including a liquid material container 1002, a housing enclosure 1014, a rotational nozzle 1024, and robot components. The liquid material container 1002 can include an injection mechanism 1004, a liquid material reservoir 1006, and a liquid material output port 1008. A type of liquid within the liquid material container 1002 can be based on an application for the robot guided rotational nozzle system 1000.

The housing enclosure 1014 can include a liquid material input port 1012, an solid straight pipe 1016, and a hollow shaft motor 1018. The hollow shaft motor 1018 can include a stator 1020 and a rotor 1022. The solid straight pipe 1016 can be fixed to the liquid material input port 1012 of the housing enclosure 1014. The liquid material output port 1008 of the liquid material container 1002 can be linked to the liquid material input port 1012 of the housing enclosure 1014 by a flexible extension pipe 1010.

The rotational nozzle 1024 can include multiple output ports 1028 and a sealed bearing 1026. A size, number, or location of the multiple output ports 1028 can depend on the application for the robot guided rotational nozzle system 1000. The rotor 1022 of the hollow shaft motor 1018 and the rotational nozzle 1024 can be fixed together so that the hollow shaft motor 1018 can continuously rotate the rotational nozzle 1024. The solid straight pipe 1016 can pass through the hollow shaft motor 1018 and can be inserted into the sealed bearing 1026 to inject liquid material inside the rotational nozzle 1024.

The robot components can include a robot control unit 1030, system and power control cables 1032 connected at a first end to the robot control unit 1030, and a mobile robot 1034 connected to a second end of the system and power control cables 1032. In some examples, the system and power control cables 1032 are not present and the robot 1034 operates remotely from the robot control unit 1030. The mobile robot 1034 can be fixed to the housing enclosure 1014 and most of a length of each of the system and power control cables 1032 can be attached to the flexible extension pipe 1010.

The robot guided rotational nozzle system 1000 can coat surfaces of objects including internal surfaces of irregular objects such as irregular object 1036. The robot guided rotational nozzle system 1000 can function as a standalone painting or coating tool specifically designed for long industrial pipes. The mobile robot 1034 can enter the pipe from one end, initiate the painting or coating process, and then move continuously with a constant speed in one direction, ensuring a thorough and uniform application until the robot 1034 reaches the opposite end, completing an internal surface treatment (painting or coating). In some examples, the irregular object 1036 can be a long and narrow industrial pipe with elbows. The coating process can involve positioning the rotational nozzle 1024 at a depth (e.g., a bottom depth) associated with the irregular object 1036. In some examples, the mobile robot 1034 can position the rotational nozzle 1024 at the depth. The rotational nozzle 1024 can be rotated by the hollow shaft motor 1018 and coating material can be continuously injected into the rotational nozzle 1024 by the solid straight pipe 1016 during the coating process. The rotational nozzle 1024 can be lifted (or lowered) in order to coat all depths (or any combination of depths) of the irregular object 1036 by the mobile robot 1034. The robot can also guide the rotational nozzle 1024 to move in a horizontal plane as well (e.g., left, right, forward, backward, or some combination of the aforementioned directions). The mobile robot 1034 can guide motion of the rotational nozzle 1024 along the elbows of long and narrow industrial pipes. Once the entire internal surface of import is coated, injection of the coating material can cease and the hollow shaft motor 1018 can stop rotating the rotational nozzle 1024.

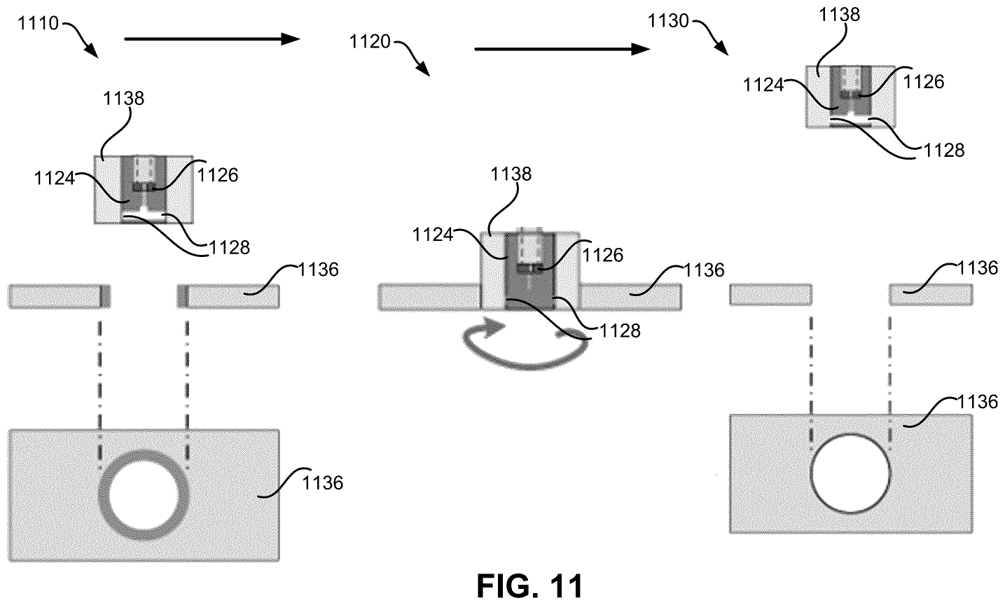

FIG. 11 is a schematic of a rotational nozzle 1124 in various stages of a cleaning process according to some aspects of the present disclosure. The rotational nozzle 1124 can be a component of a rotational nozzle system. For simplicity only the rotational nozzle 1124 component of the rotational nozzle system is shown in FIG. 11. The rotational nozzle 1124 multiple output ports 1128 and a sealed bearing 1126. The rotational nozzle 1124 can also include a sponge head 1138 for cleaning a workpiece component 1136 that includes a hole to clean before coating.

The various stages of the cleaning process can include an approach stage 1110, a cleaning stage 1120, and an extraction stage 1130. In the approach stage 1110, the rotational nozzle 1124 can be moved toward a predetermined depth within the hole of the workpiece component 1136. Once the rotational nozzle 1124 arrives at the predetermined depth, the cleaning stage 1120 of the cleaning process can begin. The rotational nozzle 1124 can be rotated by a hollow shaft motor of the rotational nozzle system and cleaning material can be continuously injected into the rotational nozzle 1124. The cleaning material can pass through the multiple output ports 1128 of the rotational nozzle 1124 and soak the sponge head 1138, which can contact and clean an interior surface of the hole in the workpiece component 1136. The rotational nozzle 1124 can be lifted or lowered to clean the interior surface at all depths of the hole or any combination of depths.

When the interior surface of the hole is cleaned, the extraction stage 1130 of the cleaning process can begin. Injection of the cleaning material can cease, and the hollow shaft motor can stop rotating the rotational nozzle 1124. The rotational nozzle 1124 can be lifted away from the hole in the workpiece component 1136 and can be moved to clean a different hole in the workpiece component 1136 or holes in a different workpiece component.

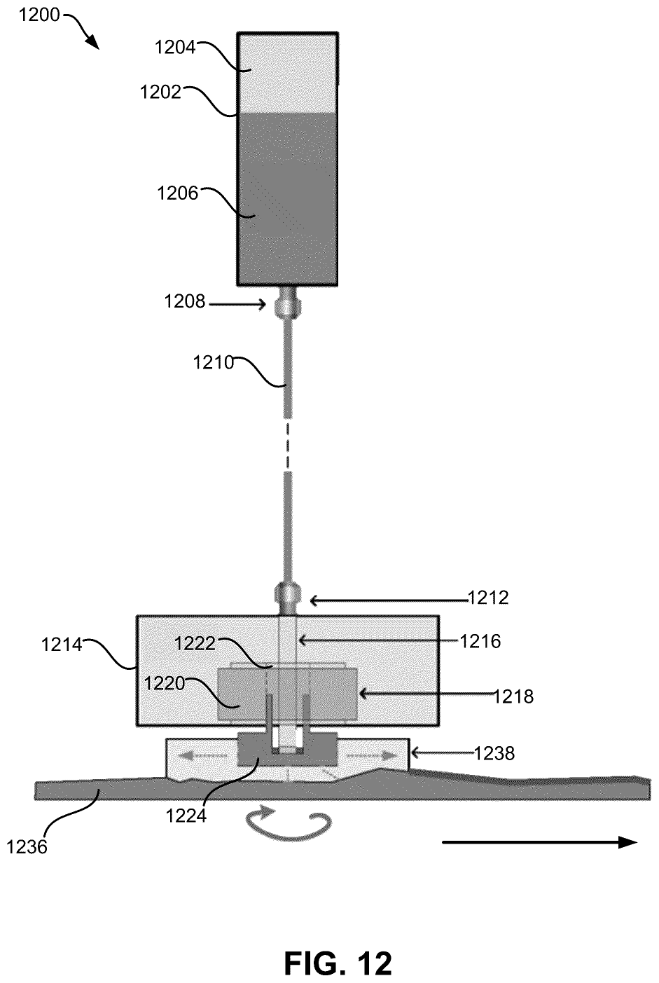

FIG. 12 is a schematic of a cross-section view of a rotational nozzle system 1200 for polishing a surface of a workpiece 1236 according to some aspects of the present disclosure. The surface of the workpiece 1236 can be a regular surface with wide curvatures and/or small irregularities. The rotational nozzle system 1200 can include three sections including a liquid material container 1202, a housing enclosure 1214, and a rotational nozzle 1224. The liquid material container 1202 can include an injection mechanism 1204, a polishing liquid material reservoir 1206, and a liquid material output port 1208. A type of liquid within the liquid material container 1202 can be polishing material for a polishing application of the rotational nozzle system 100.

The housing enclosure 1214 can include a liquid material input port 1212, a solid straight pipe 1216, and a hollow shaft motor 1218. The hollow shaft motor 1218 can include a stator 1220 and a rotor 1222. The housing enclosure 1214 can fix the stator 1220 of the hollow shaft motor 1218 and the liquid material input port 1212 together as a single unit. The solid straight pipe 1216 can be fixed to the liquid material input port 1212 of the housing enclosure 1214. The liquid material output port 1208 of the liquid material container 1202 can be linked to the liquid material input port 1212 of the housing enclosure 1214 by a flexible extension pipe 1210.

The rotational nozzle 1224 can include a single output port or multiple output ports, a sealed bearing, and a sponge head 1238. In some examples, the rotational nozzle can include a polishing brush in place of the sponge head 1238. The sponge head 1238 or the polishing brush can rotate at a same rotational speed as the rotational nozzle. A size, number, or location of the multiple output ports can depend on the application for the rotational nozzle system 1200. The rotor 1222 of the hollow shaft motor 1218 and the rotational nozzle 1224 can be fixed together so that the hollow shaft motor 1218 can continuously rotate the rotational nozzle 1224. The solid straight pipe 1216 can pass through the hollow shaft motor 1218 and be inserted into the sealed bearing 1226 to inject polishing liquid material inside the rotational nozzle 1224. The polishing liquid material can pass through the multiple output ports of the rotational nozzle 1224 and soak the sponge head 1238, which can contact and polish the surface of the workpiece 1236. Polishing material can reach the surface of the workpiece 1236 either by a centripetal force effect generated by a high-speed rotation of the rotational nozzle 1224 or by direct injection of the polishing material outside the sponge head 1238 or polishing brush. The rotational nozzle system 1200 can undergo lateral motion (as depicted by the arrows in FIG. 12) in order to polish an entire surface of the workpiece 1236. In some examples, a robotic arm, mobile robot, or handheld tool can be programmed to automatically move the rotational nozzle system 1200 in two-dimensional (2D) linear motion, such as back and forth, side to side, or some combination of lateral motion according to a motion profile such as a 2D linear motion profile. In some examples, the polishing process can be achieved by simultaneously activating rotational motion of the rotational nozzle, injection of polishing material, and automatic 2D linear motion (e.g., back and forth lateral) of the rotational nozzle system 1200.

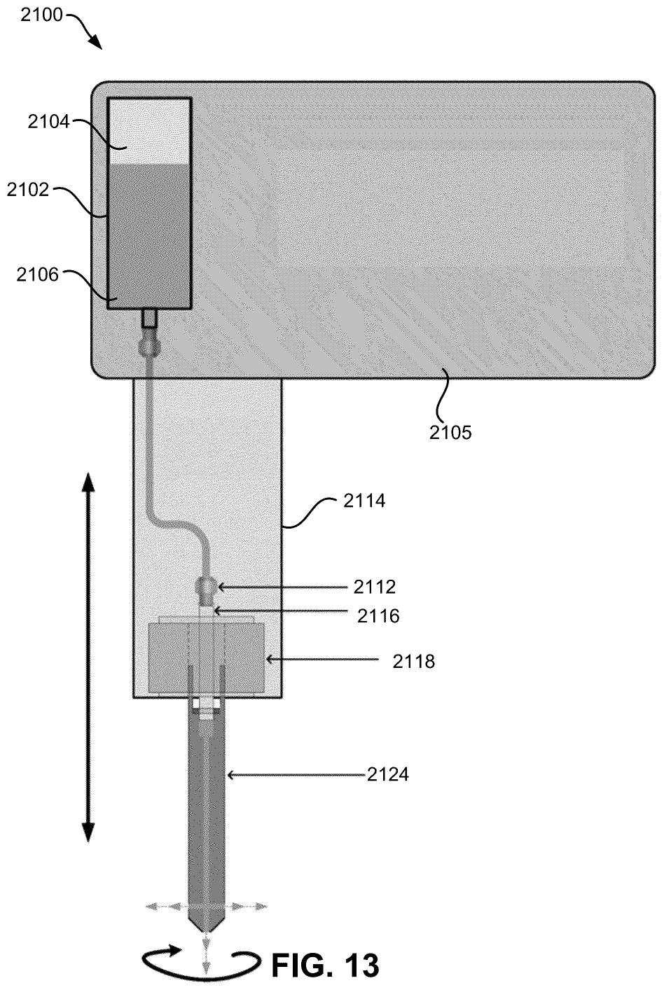

FIG. 13 is a schematic of a cross-section view of an automatic self-feeding machining bit system 2100 according to some aspects of the present disclosure. The automatic self-feeding machining bit system 2100 can be a component or an extension of a machining device 2105. Examples of the machining device 2105 can include a CNC machine, a Lathe machine, a drilling machine, etc. The automatic self-feeding machining bit system 2100 can assist with many different machining operations. Examples of the machining operations can include drilling, tapping, milling, boring, etc. The automatic self-feeding machining bit system can be capable of providing liquid material when normal systems may be incapable of providing lubricant or coolant under similar operating conditions, such as when the machining operation is a deep machining operation. The automatic self-feeding machining bit system 2100 can include three sections including a liquid material container 2102, a machine head 2114, and a machining bit 2124. The liquid material container 2102 can include an injection mechanism 2104, a liquid material reservoir 2106, and a liquid material output port. A type of liquid within the liquid material container 2102 can be based on an application for the automatic self-feeding machining bit system 2100. Types of liquid can include lubricants, water or water-based liquids, grease, oils, coolant liquids, any other liquids relevant to machining device operations, etc.

The machine head 2114 can include a liquid material input port 2112, a solid straight pipe 2116, and a hollow shaft motor 2118. The hollow shaft motor 2118 can be a high torque hollow shaft motor for machining operations. The hollow shaft motor 2118 can include a stator and a rotor. The machine head 2114 can fix the stator of the hollow shaft motor 2118 and the liquid material input port 2112 together as a single unit. The solid straight pipe 2116 can be fixed to the liquid material input port 2112 of the machine head 2114. The liquid material output port of the liquid material container 2102 can be linked to the liquid material input port 2112 of the machine head 2114 by a flexible extension pipe. In some examples, the flexible extension pipe can be a straight pipe.

The machining bit 2124 can include multiple output ports and a sealed bearing. Parameters of the automatic self-feeding machining bit system 2100 can be based on an application for the automatic self-feeding machining bit system 2100. For example, a size, number, or location of the multiple output ports can depend on the application for the automatic self-feeding machining bit system 2100. Other parameters of the automatic self-feeding machining bit system 2100 can include an inner and/or outer structure design of the machining bit 2124, a liquid material viscosity, an injection pressure of the liquid material, an inclination angle associated with each output port, etc. The number of multiple output ports can be any value including one single output port. The rotor of the hollow shaft motor 2118 and the machining bit 2124 can be fixed together so that the hollow shaft motor 2118 can continuously rotate the machining bit 2124. The solid straight pipe 2116 can pass through the hollow shaft motor 2118 without making contact with the rotor. The solid straight pipe 2116 can be inserted into an internal section of the sealed bearing with a presence of o-rings to inject liquid material inside the machining bit 2124.

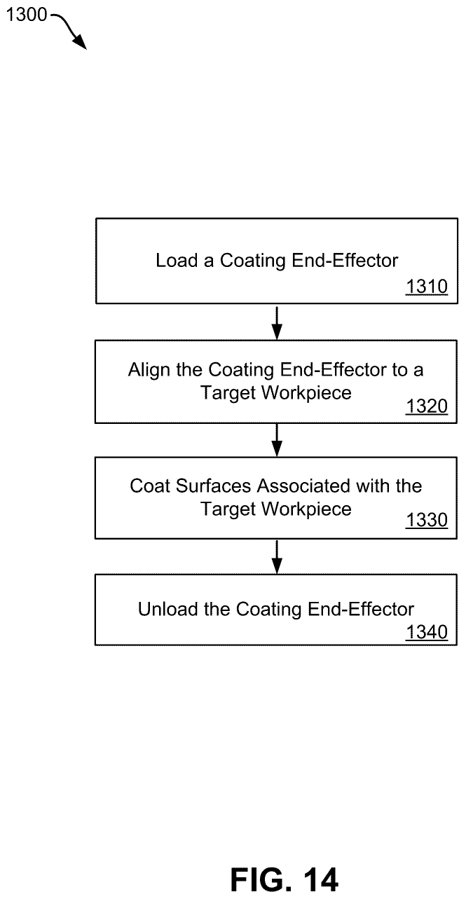

FIG. 14 is a flow chart of an example of a process 1300 for coating surfaces of a workpiece using a robot arm system according to some aspects of the present disclosure. The operations of FIG. 14 will now be described below with reference to the components described above. At block 1310, the process 1300 involves loading a coating end-effector. The coating end-effector can include a rotational nozzle system, such as any of the nozzle systems described in FIG. 1-13 above. The robot arm system can select the coating end-effector from among a group of end-effectors stored in tool holders on a main body of the robot arm system. The robot arm system can bring a robot arm manipulator near the coating end-effector and a tool changer can attach the coating end-effector to a flange of the robot arm manipulator. The robot arm manipulator can return to a position or predetermined location near the workpiece.

At block 1320, the process 1300 involves aligning the coating end-effector to a target or predetermined location on the workpiece. The target can be a hole or a specified surface in the workpiece. The robot arm system can perform vision-based control to align the coating end-effector with a target hole. The robot arm system can monitor a force feedback signal from robot arm joints to ensure that a sponge head or rotational nozzle of the coating end-effector is inside the target hole. When a rigid end of the coating end-effector touches the workpiece, force readings can increase to indicate that the sponge head or rotational nozzle has reached the hole. The robot arm system can retract the coating end-effector two millimeters or other relevant distance to avoid direct contact with the workpiece except for the sponge head or rotational nozzle.

At block 1330, the process 1300 involves coating surfaces associated with the workpiece. The surfaces can include interior surfaces of holes in the workpiece. After retracting the coating end-effector, the robot arm system can signal a microcontroller to start the coating process. The microcontroller can send a signal to a stepper motor controller of the coating end-effector to cause a hollow shaft motor to rotate the sponge head or rotational nozzle at a predetermined rotation speed and start dispensing of a coating solution. The dispensing mechanism can be controlled to precisely inject a programmable amount of coating solution inside the disposable sponge head or rotational nozzle. The programmable amount can be calculated based on measurements of an interior surface of the hole and a predetermined thickness of the coating solution. After a hole is coated, the microcontroller can send an acknowledgement signal to the robot arm system to proceed to another hole and repeat the coating process. The coating process can continue until all interior surfaces of holes in the workpiece have been coated.

At block 1340, the process 1300 involves unloading the coating end-effector. After all interior surfaces of holes of a workpiece have been coated, the robot arm manipulator can be moved near a tool holder on a robot main body of the robot arm system. The tool changer can detach the coating end-effector from the robot arm manipulator. The tool changer can then attach a different end-effector to perform other processes to a workpiece. The other end-effector can be a drilling end-effector, a deburring end-effector, or another coating end-effector that contains different coating material, such as polishing liquid material.

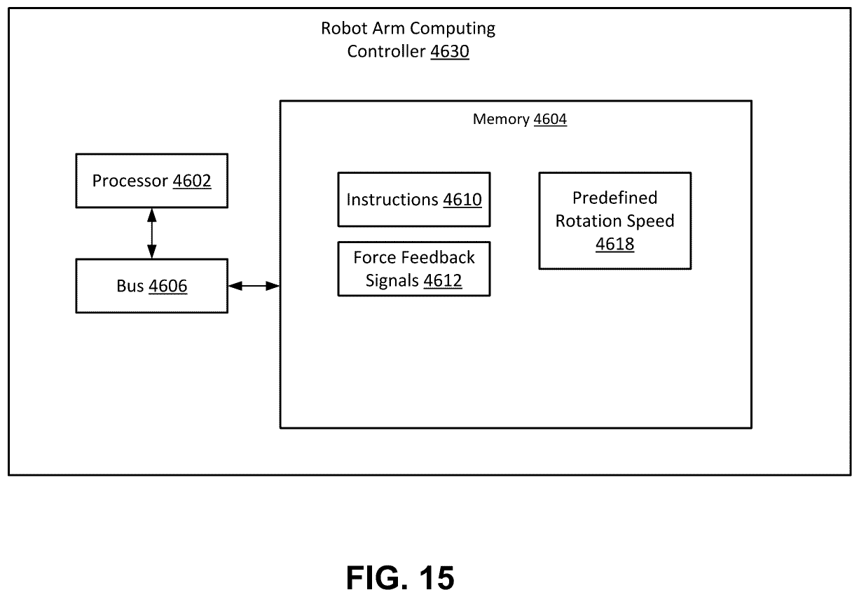

FIG. 15 is a block diagram of an example robot arm computing controller 4630 for controlling a robot arm system as the robot arm system completes manufacturing tasks such as coating tasks according to some aspects of the present disclosure. As shown, the robot arm computing controller 4630 includes a processor 4602 communicatively coupled to a memory 4604. The processor 4602 can include one processing device or multiple processing devices. Non-limiting examples of the processor 4602 include a Field-Programmable Gate Array (FPGA), an application specific integrated circuit (ASIC), a microprocessor, or any combination of these. The processor 4602 can execute instructions 4610 stored in the memory 4604 to perform operations. In some examples, the instructions 4610 can include processor-specific instructions generated by a compiler or an interpreter from code written in any suitable computer-programming language, such as C, C++, C#, Python, or Java.

The memory 4604 can include one memory device or multiple memory devices. The memory 4604 can be non-volatile and may include any type of memory device that retains stored information when powered off. Non-limiting examples of the memory 4604 include electrically erasable and programmable read-only memory (EEPROM), flash memory, or any other type of non-volatile memory. At least some of the memory 4604 can include a non-transitory computer-readable medium from which the processor 4602 can read instructions 4610. The non-transitory computer-readable medium can include electronic, optical, magnetic, or other storage devices capable of providing the processor 4602 with the instructions 4610 or other program code. Non-limiting examples of the non-transitory computer-readable medium include magnetic disk(s), memory chip(s), RAM, an ASIC, or any other medium from which a computer processor can read instructions 4610.

The memory 4604 can further include force feedback signals 4612 and a predefined rotation speed 4618. The robot arm computing controller 4630 can use the force feedback signals 4612 from joints of the robot arm system to monitor a displacement of a deburring bit of a coating end-effector while a rotational nozzle at an end of the coating end-effector is being inserted, advanced, or retracted in a workpiece. The force feedback signals 4612 or the potentiometer signal 4614 can indicate an error or deviation in the displacement of the rotational nozzle. The robot arm computing controller 4630 can respond to the error or deviation by, for example, terminating an insertion of the rotatable nozzle. A motor such as a hollow shaft nozzle of the coating end-effector can cause the rotatable nozzle to rotate with a rotation speed set to the predetermined rotation speed 4618. The robot arm computing controller 4630 can monitor the rotation speed of the rotatable nozzle. If the monitored rotation speed and the predetermined rotation speed 4618 do not match, the robot arm computing controller 4630 can cause the motor of the coating end-effector to make adjustments.

The robot arm system can use vision-based control with multiple end-effectors in manufacturing applications, such as aerospace machining applications. The robot arm system can accurately position the robot arm relative to a target workpiece. In addition, the robot arm system can select an end-effector to perform a specific machining task, such as a coating task, align the end-effector with a target on the workpiece, and perform the specific machining task with a high precision. The robot arm system can include a camera, a robotic manipulator, and customized end-effectors.

Examples of the robot arm system show that the robot arm system can precisely position end-effectors while performing machining tasks such as drilling, deburring, cleaning, painting, and polishing. Moreover, the robot arm system can perform the tasks with high accuracy, precision, and repeatability as may be required by aerospace industrial standards compared to conventional systems. The examples demonstrate a potential of a multi-end effector robot arm system in improving efficiency and reliability of manufacturing processes.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system for applying liquid materials concurrently with rotational action, the system comprising:
a rotatable nozzle comprising a plurality of output ports configured to dispense liquid material on surfaces; and
a housing enclosure comprising:
a motor configured to rotate the rotatable nozzle; and
a solid straight pipe passing through the motor configured to continuously provide the liquid material to the rotatable nozzle concurrently with rotational action.

2. The system of claim 1, wherein the plurality of output ports is configured to dispense the liquid material for a process with a predetermined thickness on surfaces.

3. The system of claim 1, wherein the motor is a hollow shaft motor comprising a stator and a rotor, the rotor configured to attach to the rotatable nozzle.

4. The system of claim 1, wherein parameters of the system are based on an application of the system.

5. The system of claim 4, wherein the parameters comprise an inner and/or outer structure design of the rotational nozzle, a rotational speed of the rotational nozzle, a liquid material viscosity, an injection pressure of the liquid material, and/or a number, size, inclination angle, type, and/or distribution of output ports.

6. The system of claim 1, wherein the plurality of output ports comprises at least one radial output port and/or at least one output port aligned with or parallel to the solid straight pipe.

7. The system of claim 1, wherein the rotatable nozzle further comprises a rotational sealed bearing, rotary shaft seal, and an O-ring, each configured to help prevent leakage outside of rotatable nozzle components.

8. The system of claim 7, wherein the O-ring is further configured to facilitate an insertion of the solid straight pipe into an internal section of the rotational sealed bearing.

9. The system of claim 1, further comprising a liquid material container connected to the solid straight pipe, the liquid material container comprising:
a liquid material reservoir; and
an injection mechanism configured to continuously inject coating material into the rotatable nozzle through the solid straight pipe.

10. The system of claim 1, further comprising a mobile robot fixed to the housing enclosure, the mobile robot configured to position and move the rotatable nozzle within an interior of a pipe.

11. The system of claim 1, wherein the system is incorporated into an endoscope system and further comprises:
an endoscope camera fixed to the housing enclosure;
an endoscope head guided motion controller configured to monitor images from the endoscope camera;
a rotational nozzle controller configured to adjust parameters for the rotational nozzle based on the monitored images; and
an endoscope probe configured to connect the endoscope camera with the endoscope head guided motion controller.

12. The system of claim 1, wherein the rotatable nozzle further comprises a sponge head configured to clean or polish surfaces.

13. A system comprising:
a robot arm system comprising:
a manipulator configured to move a coating end-effector to a predetermined location for performing an operation relative to a specified surface;
at least one coating end-effector comprising:
a rotational nozzle comprising a plurality of output ports configured to dispense liquid material on surfaces; and
a housing enclosure comprising:
a motor configured to rotate the rotatable nozzle; and
a solid straight pipe passing through the motor configured to continuously provide the liquid material to the rotatable nozzle concurrently with rotational action.

14. The system of claim 13, wherein the plurality of output ports is configured to dispense the liquid material for a process with a predetermined thickness on surfaces.

15. The system of claim 13, wherein the motor is a hollow shaft motor comprising a stator and a rotor, the rotor configured to attach to the rotatable nozzle.

16. The system of claim 13, wherein parameters of the coating end-effector are based on an application of the rotational nozzle.

17. The system of claim 16, wherein the parameters comprise an inner and/or outer structure design of the rotational nozzle, a rotational speed of the rotational nozzle, a liquid material viscosity, an injection pressure of the liquid material, and/or a number, size, inclination angle, type, and distribution of output ports.

18. The system of claim 13, wherein the plurality of output ports comprises at least one radial output port and/or at least one output port aligned with or parallel to the solid straight pipe.

19. A method for performing an operation on a specified surface with a Cobot system, the method comprising:
localizing the specified surface on a workpiece;
aligning a rotational nozzle of a coating end-effector with the specified surface;
advancing the rotational nozzle of the coating end-effector towards the specified surface; and
providing the specified surface with liquid material using the rotational nozzle of the coating end-effector while continuously providing liquid material to the rotational nozzle.

20. The method of claim 19, wherein providing the specified surface with liquid material comprises continuously coating the surface until a predetermined thickness of liquid material coats the surface.
